(19) United States
(12) Patent Application Publication
(10) Pub. No.: US 2018/0265010 A1
(43) Pub. Date: Sep. 20, 2018

(54) TWO-TIER CUSHION STORAGE SYSTEM AND INTEGRATED FEATURE OPTIONS

(71) Applicant: Ford Global Technologies, LLC, Dearborn, MI (US)

(72) Inventors: Johnathan Andrew Line, Northville, MI (US); Marcos Silva Kondrad, Macomb, MI (US); Kevin Wayne Preuss, Berkley, MI (US); Keith Allen Godin, Dearborn, MI (US); David Frederick Lyons, New Haven, MI (US); Daniel Ferretti, Commerce Township, MI (US); Suzanne Ritter, Superior Charter Township, MI (US)

(73) Assignee: Ford Global Technologies, LLC, Dearborn, MI (US)

(21) Appl. No.: 15/461,147

(22) Filed: Mar. 16, 2017

(51) Int. Cl. B60R 7/04; B60N 2/30; B60N 2/22

(52) U.S. Cl. CPC B60R 7/043; B60N 2/22; B60N 2/305

(57) ABSTRACT

A seating assembly includes a base. A cushion assembly is rotatably coupled with the base proximate a forward portion of the cushion assembly. A first seat storage compartment is disposed within the base and includes a moveable lower wall. A second seat storage compartment is disposed below the first seat storage compartment and is accessible upon movement of the moveable lower wall. At least one peripheral storage compartment is disposed on an outside wall of the base.

### FIELD OF THE DISCLOSURE

The present disclosure generally relates to a cushion storage system for a seating assembly, and more particularly to a two-tier cushion storage system and integrated feature options for a seating assembly.

### BACKGROUND OF THE DISCLOSURE

Seating assemblies and the flexible nature of those seating assemblies is becoming more important in today's world. The value of having an adjustable seating assembly provides increased worktime and increased comfort to an individual. Some seating assemblies include upper thoracic support that is adjustable between forward and rearward positions. Providing an aesthetically pleasing upper back support that is consistent with and generally seamless with the remainder of the seat provides value to the consumer.

### SUMMARY OF THE DISCLOSURE

According to one aspect of the present disclosure, a seating assembly includes a base and a cushion assembly rotatably coupled with the base proximate a forward portion of the cushion assembly. A first seat storage compartment is disposed within the base and includes a moveable lower wall. A second seat storage compartment is disposed below the first seat storage compartment and is accessible upon movement of the moveable lower wall. At least one peripheral storage compartment is disposed on an outside wall of the base.

According to another aspect of the present disclosure, a seating assembly includes a base and a cushion assembly rotatably coupled with the base proximate a forward portion of the cushion assembly. A first storage compartment is disposed within the base and includes a moveable lower wall. A second storage compartment is disposed below the first storage compartment and is accessible upon movement of the moveable lower wall.

According to yet another aspect of the present disclosure, a seating assembly includes a base and a cushion assembly rotatably coupled with a forward portion of the base and is operable to maintain an open position. A first storage compartment is disposed within the base and includes a rotatable lower wall rotatably coupled with a forward portion of an internal wall of the base and is operable to maintain an open position. A second storage compartment is disposed below the rotatable lower wall.

According to still another aspect of the present disclosure, a seating assembly is configured for use inside a vehicle and includes a base and a cushion assembly rotatably coupled therewith. First and second storage compartments are disposed below the cushion assembly and provide storage space to an occupant. One or more of the first and second storage compartments may be lockable such that personal items and items of value can be secured within the vehicle. The seating assembly as set forth herein provides an efficient use of space that is frequently overlooked within a vehicle.

These and other aspects, objects, and features of the present disclosure will be understood and appreciated by those skilled in the art upon studying the following specification, claims, and appended drawings.

### BRIEF DESCRIPTION OF THE DRAWINGS

In the drawings:

FIG. 1 is a top perspective view of one embodiment of a seating assembly of the present disclosure disposed inside a vehicle;

FIG. 2 is a top perspective view of a seating assembly of the present disclosure;

FIG. 2A is a top perspective view of the seating assembly of FIG. 2 with a seatback in a fully reclined position;

FIG. 3 is a top rear perspective view of a seating assembly of the present disclosure;

FIG. 4 is an enlarged top perspective view of a seat of a seating assembly of the present disclosure with a cushion assembly in an open position;

FIG. 5 is a top perspective view of a seating assembly of the present disclosure with a cushion assembly in an open position and with a lower wall in a closed position;

FIG. 6 is a top perspective view of the seating assembly of FIG. 5 with the cushion assembly in an open position and the lower wall in an open position; and

FIG. 7 is a front perspective view of a seating assembly of the present disclosure with a split cushion assembly.

### DETAILED DESCRIPTION OF THE EMBODIMENTS

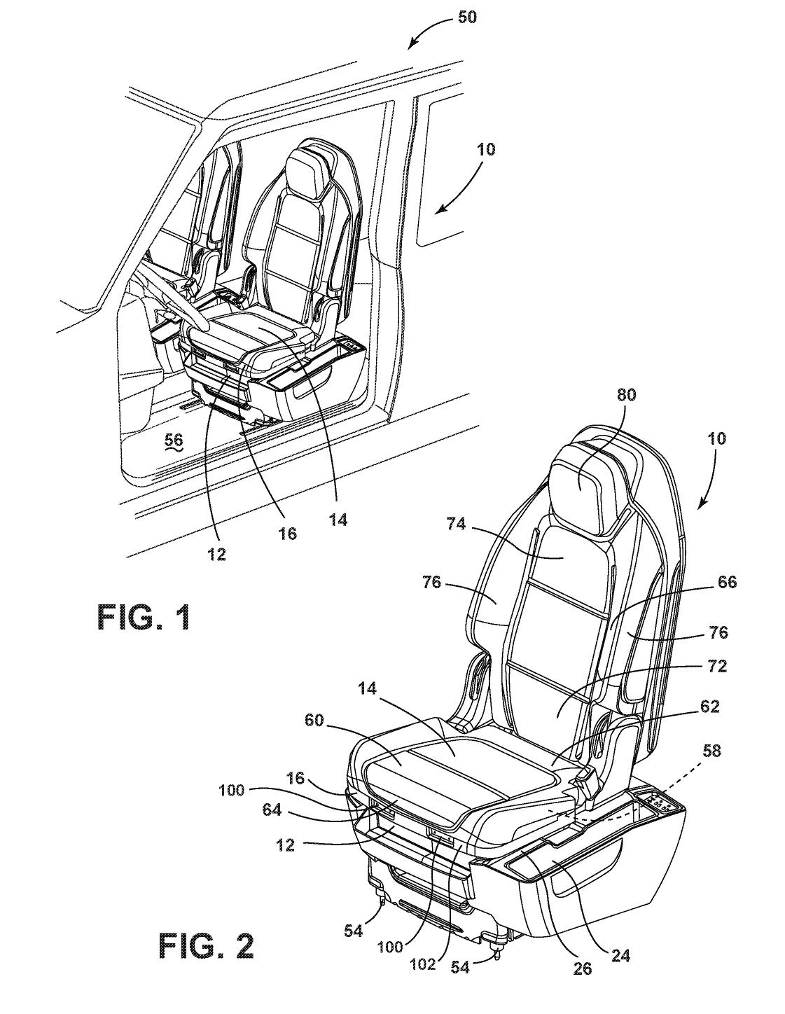

For purposes of description herein, the terms “upper,” “lower,” “right,” “left,” “rear,” “front,” “vertical,” “horizontal,” and derivatives thereof shall relate to the disclosure as oriented in FIG. 1. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Referring to the embodiment generally illustrated in FIGS. 1-7, reference numeral 10 generally designates a seating assembly that includes a base 12 and a cushion assembly 14 rotatably coupled with the base 12 proximate a forward portion 16 of the cushion assembly 14. A first seat storage compartment 18 is disposed within the base 12 and includes a moveable lower wall 20. A second seat storage compartment 22 is disposed below the first seat storage compartment 18 and is accessible upon movement of the moveable lower wall 20. At least one peripheral storage compartment 24 is disposed on an outside wall 26 of the base 12.

With reference to FIG. 1, the seating assembly 10 is generally constructed for use in a variety of environments, including residential or commercial applications, as well as in vehicles 50. The seating assembly generally includes the base 12, which is supported on feet 54. The feet 54 may be operably coupled with a floor 56 of the vehicle 50. It will be understood that the feet 54 may be slidably coupled with the floor 56 (FIG. 1) or may maintain a stationary position relative to the floor 56 of the vehicle 50. The base 12 extends upwardly from the feet 54 and is configured to support a suspension assembly 58 and a seat 60. The seat 60 includes the cushion assembly 14, which is configured to provide comfort to an occupant. In addition, the seat 60 includes a rearward portion 62 and a forward portion 64. The forward portion 64 may include underlying independent thigh supports configured to independently support each leg of an occupant. A seatback 66 is operably coupled with the seat 60 and is configured to pivot relative to the seat 60. In addition, the seatback 66 may include one or more seatback arms pivotally coupled with the seatback 66. The seatback arms are designed to provide support to the arms of an occupant. The seatback 66 includes a lower lumbar cushion 72 and an upper thoracic cushion 74. The upper thoracic cushion 74 may include a paddle configured to rotate forward relative to the seatback 66 to provide upper back support to an occupant. The seatback 66 also includes side bolsters 76 configured to cradle the sides of an occupant. A head restraint 80 is disposed on the seatback 66 and is operable between a plurality of extendable positions relative to the seatback 66.

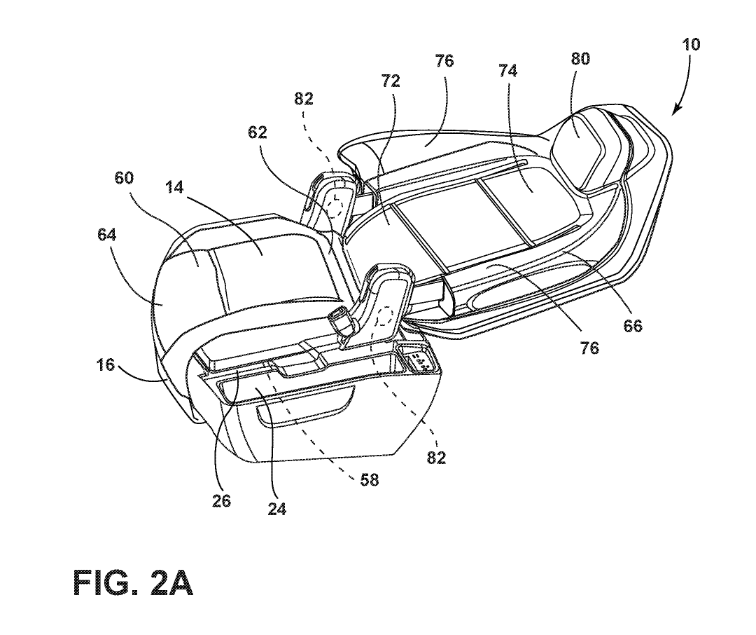

Referring now to FIGS. 2 and 2A, the seating assembly 10 is generally configured to provide sleeping accommodations to an occupant. Accordingly, the seatback 66 is configured to pivot rearward about recliner hearts 82 relative to the seat 60, such that the seat 60 and the seatback 66 are laterally aligned or nearly laterally aligned (FIG. 2A). In this configuration, the seating assembly 10 can provide comfort to an occupant that wishes to rest or sleep for a period of time without leaving the safety of the vehicle 50. In an effort to provide increased comfort and support to the upper back of an occupant, the upper thoracic cushion 74 can rotate forward into abutting contact with an upper portion of the back of an occupant. This additional support can lessen strain on the head and neck of the occupant.

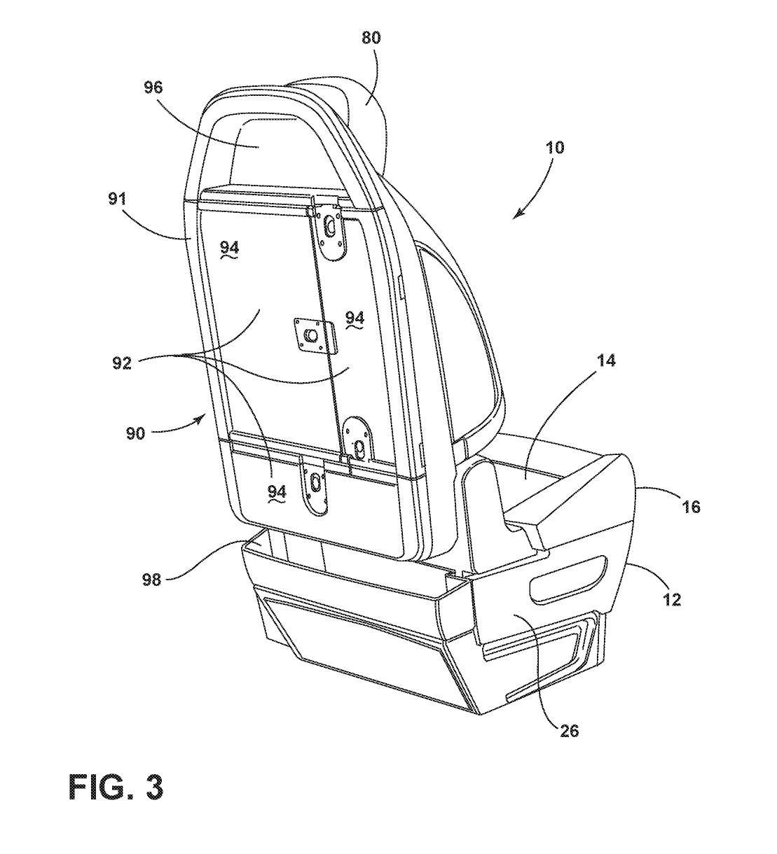

With reference now to FIG. 3, the seatback 66 may include storage features 90 on a back side thereof. In the illustrated embodiment, a rear surface 91 of the seatback 66 includes a plurality of storage compartments 92, including doors 94 that can be opened to provide access to the plurality of storage compartments 92. The plurality of storage compartments 92 are generally configured to store office supplies, mobile devices, etc. the doors 94 may include latches or locks to keep the doors 94 closed or prohibit unauthorized access to the plurality of storage compartments 92. To provide a desk-like work surface, the seatback 66 can be folded forward, such that the back surface of the seatback 66 is generally horizontal. In this position, the rear surface 91 of the seatback 66 can be used as a work surface and the various compartments can be readily accessed. The rear surface 91 of the seatback 66 may also include a trough 96 (proximate the head restraint 80) and a storage bin 98 proximate the base 12 of the seat 60. It will be understood that any of the compartments, troughs, or storage bins may include charging adapters configured to receive a plug for charging a mobile device or laptop, and may also include inductive charging capabilities to charge mobile devices or laptops.

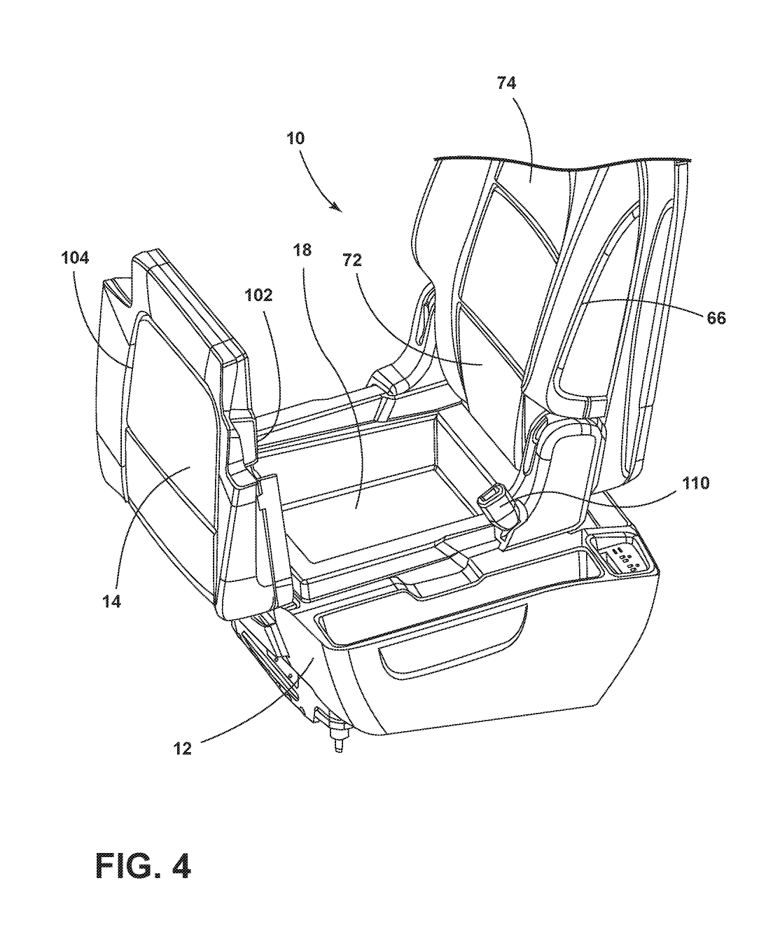

With reference now to FIG. 4, in the illustrated embodiment, the cushion assembly 14 is configured to rotate forward about hinges 100 disposed on a front side of the base 12. The cushion assembly 14 is configured to provide support to an occupant and includes a lightweight lid 102 that can easily be rotated upward and forward to reveal the first seat storage compartment 18. It is generally contemplated that the lid 102 may be constructed from a glass filled nylon, which provides a strong, yet lightweight, structure. In addition, the lid 102 of the first seat storage compartment 18 may act as a dynamic frontal impact energy management system above the base 12 that supports the occupant during a collision event. Stated differently, during a collision event, the lid 102 acts to control forces received from a load placed on the lid 102 by the occupant in relation to the collision event. It will also be understood that the lid 102, which supports an underside of a cushion support 104 of the cushion assembly 14, may be rotatable about the forward portion 16 of the base 12, as illustrated in FIG. 4, but also may be rotatable about the rearward portion 62 of the base 12 or a side portion of the base 12. The manner in which the cushion support 104 and the lid 102 rotate may be dictated by the intended use of the vehicle 50 and the seating assembly 10 within the vehicle 50. Notably, a seatbelt receiver 110 disposed on one side of the base 12 is generally spaced from the cushion assembly 14 to allow for easy movement of the cushion support 104 between open and closed positions. Moreover, the seatback 66 is also constructed, such that the seatback 66 does not prohibit opening of the lid 102 and the cushion support 104 to expose the first seat storage compartment 18. However, it will be understood that when the seatback 66 is rotated forward to provide access to the work surface on the rear side 91 of the seatback 66, the first seat storage compartment 18 may be generally inaccessible.

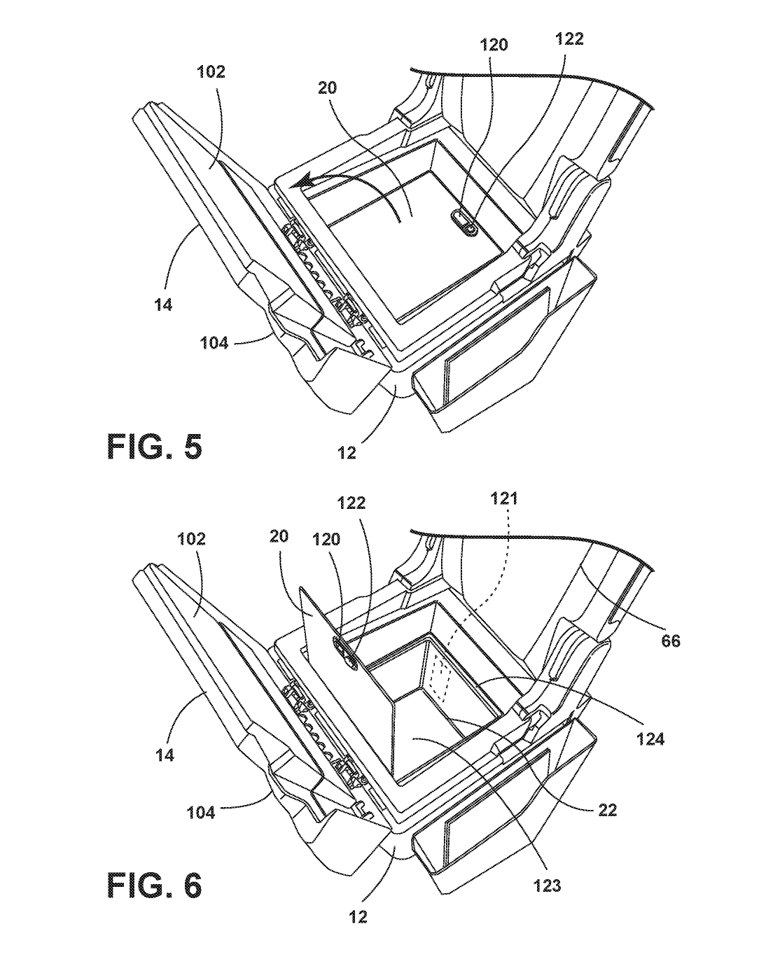

With reference now to FIGS. 5 and 6, the seating assembly 10 may also include the second seat storage compartment 22 disposed below the first seat storage compartment 18 and accessible upon movement of the moveable lower wall 20. The second seat storage compartment 22 may generally be concealed such that it is not readily noticeable that the second seat storage compartment 22 is present within the seating assembly 10. Moreover, the second seat storage compartment 22, and more specifically, the moveable lower wall 20, may include a latch 120 and possibly a locking feature 122 that prohibits unauthorized access to the second seat storage compartment 22. Accordingly, the second seat storage compartment 22 may be used for securing dangerous or valuable items. Further, it is contemplated that the second seat storage compartment 22 may also include a refrigerating unit 121 configured to cool a well 123 of the second seat storage compartment 22. The well 123 of the second seat storage compartment 22 may include any of a variety of depths that extend to the floor 56 of the vehicle 50. The moveable lower wall 20 is configured to rest on an upper lip 124 that extends about a periphery of the well 123. It is also contemplated that the well 123 may extend below a surface of the floor 56 and a recess of the floor 56 to provide additional storage space below the seating assembly 10. It will also be understood that, like the lid 102 of the first seat storage compartment 18, the moveable lower wall 20 of the second seat storage compartment 22 may rotate about a front portion of the base 12, or may rotate about the rearward portion 62 of the base 12, or either side of the base 12. The manner in which the moveable lower wall 20 rotates may be dictated by the intended use of the vehicle 50 and the seating assembly 10. Further, the moveable lower wall 20 may be fully removable from the seating assembly 10. The moveable lower wall 20 may also include an inductive charging unit configured to charge a mobile electronic device.

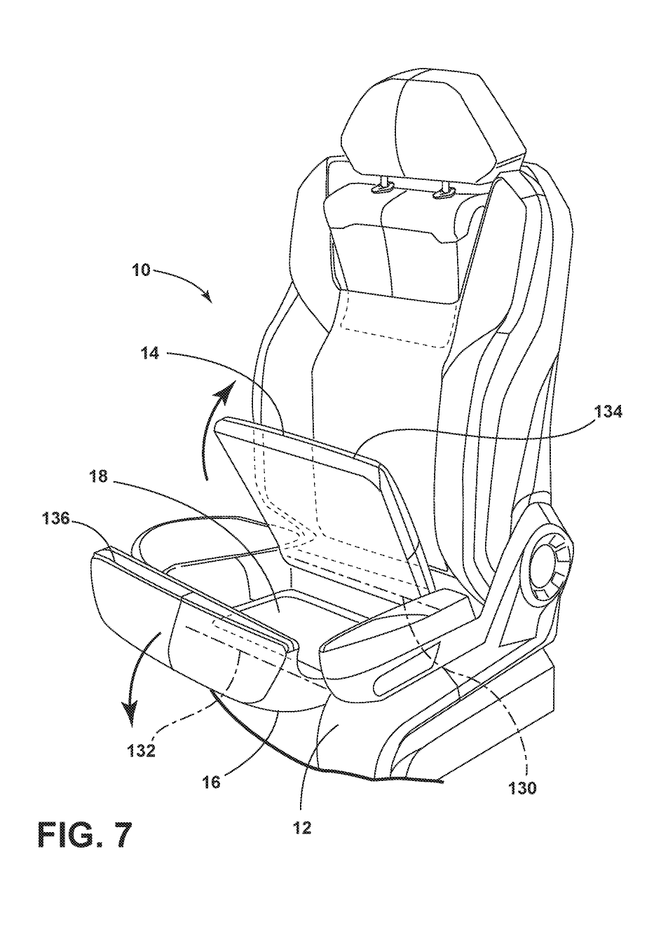

With reference now to FIG. 7, an alternate construction for the seating assembly 10 has a split cushion and split lid assembly, which includes the rearward portion 62 of the seating assembly 10 and the lid 102, rotating back about a rear pivot axis 130, and the forward portion 64 of the seating assembly 10 and the lid 102 rotating forward and downward about a front pivot axis 132. The first seat storage compartment 18 would otherwise maintain a volume similar to the embodiments discussed above, but provides a different manner in which to access the first seat storage compartment 18. A front lip 134 of the rearward portion 62 of the cushion assembly 14 may be tapered to engage a receiving slot 136 defined in the forward portion 64 of the cushion assembly 14. This mating engagement provides a clean aesthetic appearance without any noticeable breaks in the cushion assembly 14. It will be understood that the rearward portion 62 and the forward portion 64 may be unlocked via a push/push actuation feature, an unlock button, etc., to reveal the storage compartments 92 available below the cushion assembly 14.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or moveable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. A seating assembly comprising:
a base;
a cushion assembly rotatably coupled with the base proximate a forward portion of the cushion assembly;
a first seat storage compartment disposed within the base and including a moveable lower wall;
a second seat storage compartment disposed below the first seat storage compartment and accessible upon movement of the moveable lower wall; and
at least one peripheral storage compartment disposed on an outside wall of the base.

2. The seating assembly of claim 1, wherein the moveable lower wall includes a locking feature.

3. The seating assembly of claim 1, wherein the second seat storage compartment includes a refrigerating unit configured to cool a well of the second seat storage compartment.

4. The seating assembly of claim 1, wherein the moveable lower wall includes an inductive charging unit configured to charge a mobile electronic device.

5. The seating assembly of claim 1, wherein the at least one peripheral storage compartment is located on a forward side of the base.

6. The seating assembly of claim 1, wherein the cushion assembly includes a cushion support defining a lid of the first seat storage compartment.

7. The seating assembly of claim 6, wherein the lid is constructed from a glass-filled nylon.

8. The seating assembly of claim 6, wherein the first seat storage compartment and the lid act as a dynamic frontal impact energy management system above the base to support an occupant during a collision event.

9. The seating assembly of claim 6, wherein a first portion of the lid is rotatably coupled with the base proximate the forward portion of the cushion assembly and a second portion of the lid is rotatably coupled with the base proximate a rearward portion of the base.

10. A seating assembly comprising:
a base;
a cushion assembly rotatably coupled with the base proximate a forward portion of the cushion assembly;
a first storage compartment disposed within the base and including a moveable lower wall; and
a second storage compartment disposed below the first storage compartment and accessible upon movement of the moveable lower wall.

11. The seating assembly of claim 10, wherein the moveable lower wall includes a locking feature.

12. The seating assembly of claim 10, wherein the moveable lower wall includes an inductive charging unit configured to charge a mobile electronic device.

13. The seating assembly of claim 10, wherein the cushion assembly includes a cushion support defining a lid of the first storage compartment.

14. The seating assembly of claim 13, wherein the lid is constructed from a glass-filled nylon.

15. The seating assembly of claim 13, wherein the first storage compartment and the lid act as a dynamic frontal impact energy management system above the base to support an occupant during a collision event.

16. The seating assembly of claim 13, wherein a first portion of the lid is rotatably coupled with the base proximate the forward portion of the cushion assembly and a second portion of the lid is rotatably coupled with the base proximate a rearward portion of the base.

17. A seating assembly comprising:
a base;
a cushion assembly rotatably coupled with a forward portion of the base and operable to maintain an open position;
a first storage compartment disposed within the base and including a rotatable lower wall rotatably coupled with a forward portion of an internal wall of the base and operable to maintain an open position; and
a second storage compartment disposed below the rotatable lower wall.

18. The seating assembly of claim 17, wherein the rotatable lower wall includes a locking feature.

19. The seating assembly of claim 17, wherein the cushion assembly includes a cushion support defining a lid of the first storage compartment.

20. The seating assembly of claim 19, wherein the first storage compartment and the lid act as a dynamic frontal impact energy management system above the base to support an occupant during a collision event.
